(19) United States
(12) Patent Application Publication
(10) Pub. No.: US 2007/0041589 A1
(43) Pub. Date: Feb. 22, 2007

(54) System and method for providing environmental specific noise reduction algorithms

(75) Inventors: Atin Patel, Mississauga (CA); Gora Ganguli, Burlington (CA); Randall Mileski, Burlington (CA); Cameron K. Smith, Oakville (CA); Sukhminder Binapal, Burlington (CA); Kamal Ali, Oakville (CA)

Correspondence Address: Joseph M. Sauer, Esq.;Jones Day, North Point, 901 Lakeside Avenue, Cleveland, OH, 44114, US

(73) Assignee: Gennum Corporation

(21) Appl. No.: 11/205,403

(22) Filed: Aug. 17, 2005

(51) Int. Cl. H04R 3/02

(52) U.S. Cl. 381/73.1

(57) ABSTRACT

In accordance with the teachings described herein, systems and methods are provided for providing environmental specific noise reduction algorithms (ESNRAs) in a head-mounted device. A network server may be used to store a plurality of ESNRAs. One or more of the ESNRAs may be downloaded from the network server for use in the head-mounted device. The head-mounted device may use one or more of the downloaded ESNRAs to filter environmental noise from an audio signal.

### FIELD

The technology described in this patent document relates generally to the field of communication head-mounted devices. More particularly, the patent document describes a boomless head-mounted device that is particularly well-suited for use as a wireless headset for communicating with a cellular telephone. The head-mounted device is capable of processing incoming noise with environment specific noise reduction algorithms and transmitting a noise-reduced sound wave to the user. In addition, the head-mounted device can be used as a digital hearing aid.

### BACKGROUND

Wireless head-mounted devices are used to wirelessly connect to a user's cell phone thereby enabling hands-free use of a cell-phone. The wireless link can be established using a variety of technologies, such as the Bluetooth short range wireless technology. In high ambient noise environments, which may include unwanted nearby voices as well as other types of environmental noise, the head-mounted device, through its microphone, may pick up the user's voice and the ambient noise, and transmit both to the receiving party. The user may also be receiving sounds from the cell-phone that have a high level of environmental noise, making it difficult to hear the person the user is trying to communicate with. This often makes conversations difficult to carry on between two parties. Furthermore, in face-to-face communications a high level of environmental noise may also make it difficult to hear the person the user is trying to communicate with.

### SUMMARY

A system is described and claimed that provides environment specific noise reduction in a head-mounted device. The system includes a network server that communicates over a network. The server stores a plurality of environment specific noise reduction algorithms (ESNRAs). The system also includes a network device that communicates with the network. The network device is operable to download one or more of the plurality of ESNRAs from the network server for use in a head-mounted device.

### BRIEF DESCRIPTION OF THE DRAWINGS

FIG. 1 is a block diagram of an example communications head-mounted device having signal processing capabilities.

FIG. 2 is a block diagram of an example digital signal processor.

FIGS. 3A-3C are a series of directional response plots that may be generated using the digital signal processor described herein.

FIG. 4 is a block diagram of an example communication head-mounted device having signal processing capabilities in which a pair of signal processors are provided for enhancing the performance of the head-mounted device.

FIG. 5 is a block diagram of another example digital signal processor.

FIG. 6 is a block diagram of an example communication head-mounted device having signal processing capabilities and a pair of signal processors.

FIGS. 7A and 7B are a block diagram of an example digital hearing instrument system.

FIGS. 8 and 9 are block diagrams of an example communication head-mounted device having signal processing capabilities and also providing wired and wireless audio processing.

FIG. 10 is a block diagram of an example network system for making environment specific noise reducing algorithms available over a network.

FIG. 11 is a block diagram of an example system for utilizing environment specific noise reducing algorithms.

FIG. 12 is a block diagram of a second example system for utilizing environment specific noise reducing algorithms including an algorithm generating processor.

FIG. 13 is a block diagram of an example head-mounted device that is operable to process audio signals with environment specific noise reducing algorithms to transmit a noise reduced signal to a user.

FIG. 14 is an example web-page showing environment specific noise reducing algorithms available for download to a network device.

FIG. 15 is a block diagram of an example system for creating individually tailored environment specific noise reduction algorithms.

### DETAILED DESCRIPTION

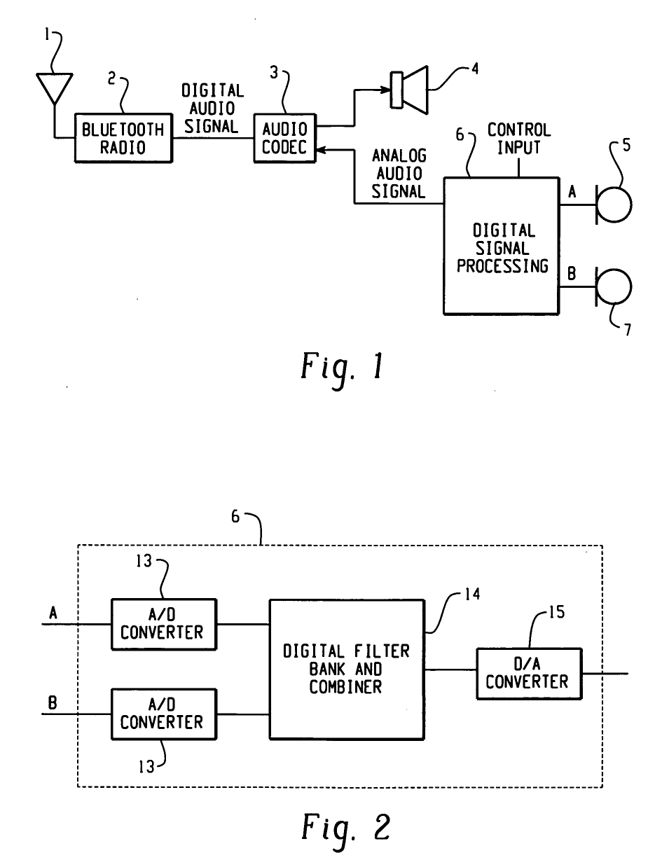

FIG. 1 is a block diagram of an example communications head-mounted device having signal processing capabilities. This example wireless head-mounted device includes a digital signal processor 6 in the microphone path. The illustrated wireless head-mounted device may, for example, be used to establish a wireless link (e.g., a Bluetooth link) with an external device, such as a cell phone or PDA, in order to send and receive audio signals. Other types of wireless links could also be utilized, and the device may be configured to communicate with a variety of different external devices, such as cellular phones, PDAs, radios, MP3 players, CD players, portable game machines, etc. The wireless head-mounted device includes an antenna 1, a radio 2 (e.g., a Bluetooth radio), an audio codec 3, and a speaker 4. In addition, the wireless head-mounted device further includes a digital signal processor 6 and a pair of microphones 5, 7.

Incoming audio signals may be transmitted from the external device over the wireless link to the antenna 1. The received audio signal is then converted from a radio frequency (RF) signal to a digital signal by the radio 2. The digital audio output from the radio 2 is transformed into an analog audio signal by the audio CODEC 3. The analog audio signal from the audio CODEC 3 is then transmitted into the ear of the wireless head-mounted device user by the speaker 4. In other examples, communications between the radio 2 and the digital signal processor 6 may be in the digital domain. For instance, in one example the audio CODEC 3 or some other type of D/A converter may be embedded within the radio circuitry 2.

Outgoing audio signals (e.g., audio spoken by the head-mounted device user) are received by the microphones 5, 7. The audio signals received by the microphones 5, 7 are routed to inputs A and B of the digital signal processor 6, respectively.

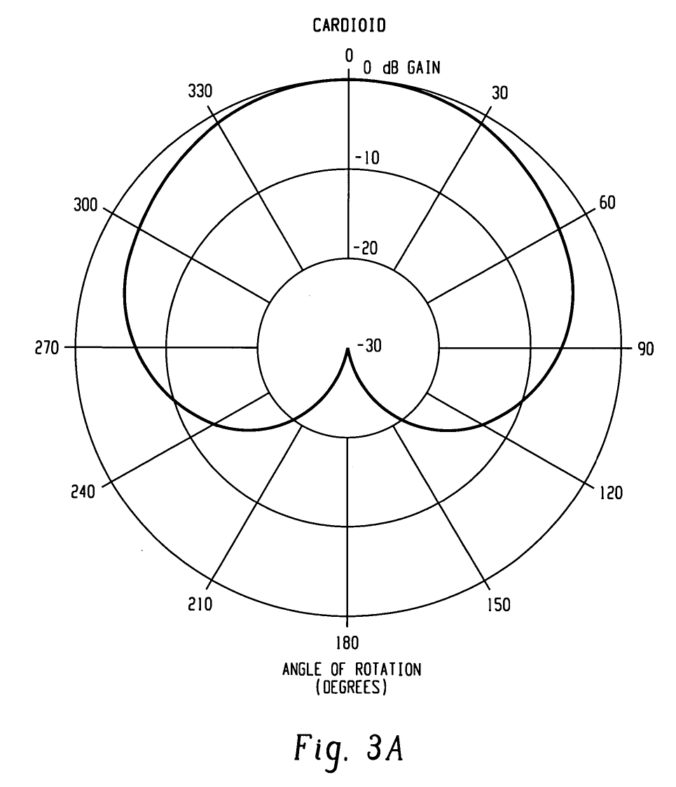

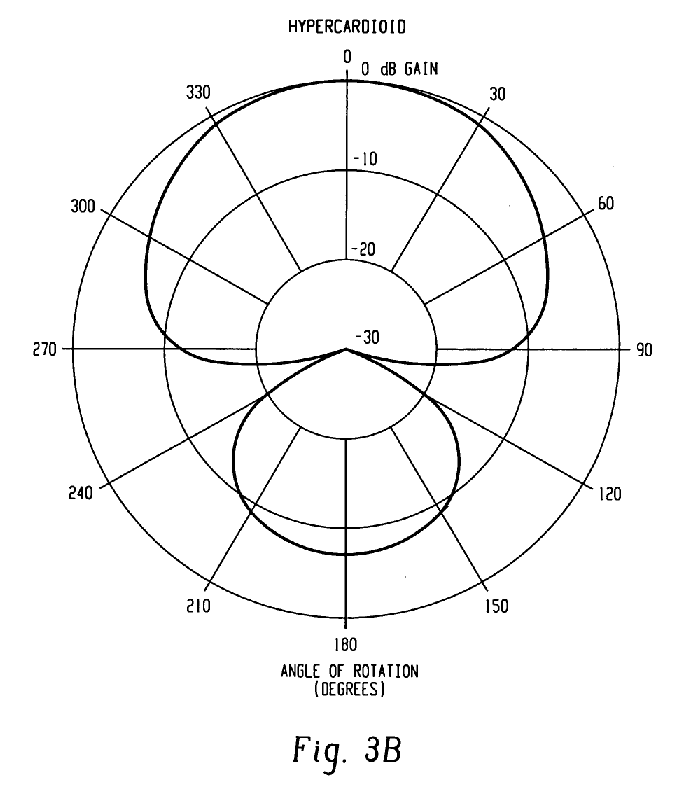

FIG. 2 is a block diagram of an example digital signal processor. The audio signals from the microphones 5, 7 are digitized by analog to digital converters (A/D) 13, processed through a filter bank 14 to optimize the overall frequency response and combined in a manner that can effectively create a desired directional response, such as shown in FIG. 3A-3C. The combined digital audio signal is then transformed back to analog audio by the digital to analog converter (D/A) 15 and output from the digital signal processor 6. With reference again to FIG. 1, the analog output of the digital signal processor 6 is converted into a digital audio signal by the audio CODEC 3. The digital audio output from the audio CODEC 3 is then converted to an RF signal by the radio 2, and is transmitted to the external device by the antenna 1.

By integrating a signal processor 6 and microphones 5, 7 into the communication head-mounted device, a directional response can be generated that eliminates the need for a mechanical boom extending out from the head-mounted device. This may be achieved by focusing the voice field pickup and also by eliminating the ambient noise environment. The elimination of the mechanical boom allows the head-mounted device to be made smaller and more comfortable for the user, and also less obtrusive. Moreover, because the signal processor 6 is programmable, it can generate a number of different directionality responses and thus can be tailored for a particular user or a particular environment. For example, the control input to the digital signal processor 6 may be used to select from different possible directionality responses, such as the directional responses illustrated in FIGS. 3A-3C.

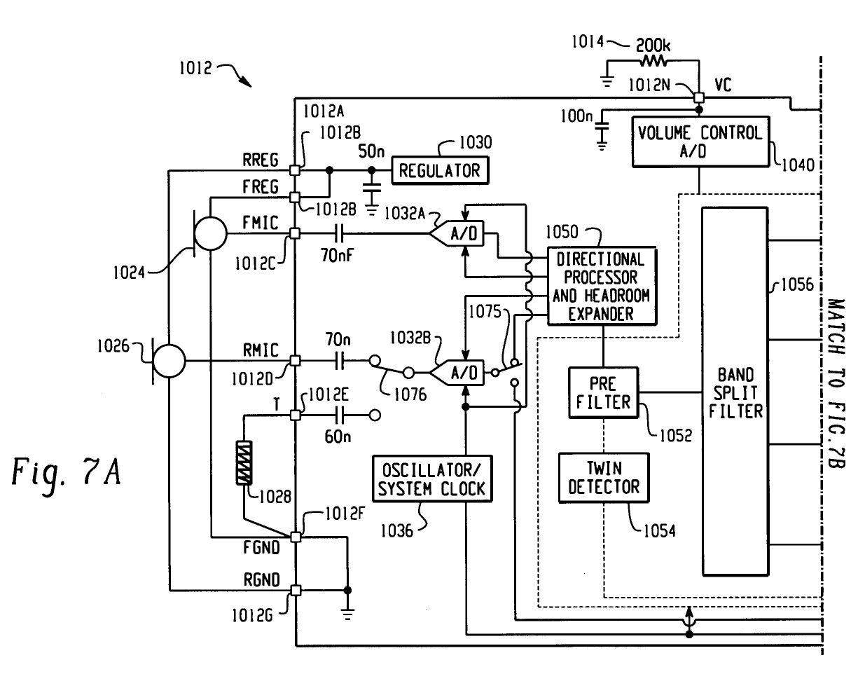

In addition, the signal processor 6 may enable the head-mounted device to operate in a second mode as a programmable digital hearing aid device. An example digital hearing aid system is described below with reference to FIGS. 7A and 7B. In a dual-mode wireless head-mounted device, the processing functions of the digital hearing aid system of FIGS. 7A and 7B may, for example, be implemented with the head-mounted device signal processor(s). Additional hearing instrument processing functions which may be implemented in a dual-mode wireless head-mounted device, including further details regarding the directional processing capability of the device, are described in commonly owned U.S. patent application Ser. No. 10/383,141, which is incorporated herein by reference. It should be understood that other digital hearing instrument systems and functions could also be implemented in the communication head-mounted device. In addition, the digital processing functions may also be used for a user without a hearing impairment. For instance, the processing functions the digital signal processor may be used to compensate for the changes in acoustics that result from positioning a headset earpiece into the ear canal.

By integrating hearing instrument processing functions into the head-mounted device described herein, a multi-mode communication device is provided. This multi-mode communication device can be used in a first mode in which the directionality of the microphones are configured for picking up the speech of the user, and in a second mode in which the directionality of the microphones are configured to hear the speech of a nearby person to whom the user is communicating. For example, in the first mode, the head-mounted device may communicate with an external device, such as a cell phone or PDA, and in the second mode the head-mounted device may be used as a digital hearing aid.

The control input to the digital signal processor 6 may, for example, be used to switch between different head-mounted device modes (e.g., communication mode and hearing instrument mode). In addition, the control input may be used for other configuration purposes, such as programming the hearing instrument settings, turning the head-mounted device on and off, setting up the conditions of directionality, or others. The control input may, for example, be received wirelessly via the radio 2, or may be received through a direct connection to the head-mounted device or via one or more user input devices on the head-mounted device (e.g., a button, a toggle switch, a trimmer, etc.)

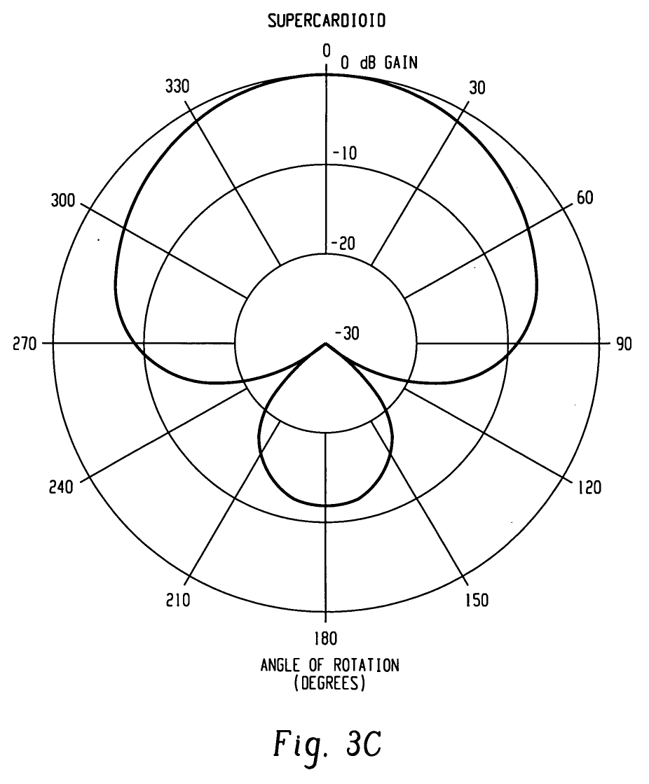

FIG. 4 is a block diagram of an example communication head-mounted device having signal processing capabilities in which a pair of signal processors 26, 28 are provided. In this example, a second digital signal processing block 28 is provided in the receiver (i.e., speaker) path between an audio CODEC 23 and a speaker 24. The analog audio output from the audio CODEC 23 is connected to input A of the signal processor 28, where it is digitized and processed to correct impairments in the overall frequency response. In another example, the digital audio signal from the radio 22 may be input directly to input A of the signal processor 28, instead of being first converted to the analog domain by CODEC 23. Input B of the signal processor 28 is connected 17 to one 27 of a pair of head-mounted device microphones 25, 27.

In one example, the head-mounted device microphone 27 connected to Input B of the signal processor 28 may be an inner-ear microphone. That is, the microphone 27 may be positioned to receive audio signals from within the ear canal of a user of the head-mounted device. The audio signals received from the inner-ear microphone 27 may, for example, be used by the signal processor 28 to reduce the effects of occlusion, particularly when the head-mounted device is operating in a hearing instrument mode. As described below, the occlusion of the ear canal may cause amplification of the user's own voice within the ear canal. This is commonly known as the occlusion effect. In order to reduce the occlusion effect, the audio signal received by the inner-ear microphone 27 may be subtracted from the audio signal being transmitted into the user's ear canal by the speaker 24. One example processing system for reducing occlusion is described below with reference to FIGS. 7A and 7B.

In another example, the occlusion effect may be reduced by providing a sample of environmental sounds to the user's ear. In this example, the microphone 27 connected to Input B of the processor 28 may be one of a pair of external microphones. Environmental sounds (i.e., audio signals from outside of the ear canal) may be received by the microphone 27 and introduced by the signal processor 28 into the audio signal being transmitted into the ear canal in order to reduce occlusion. By electronic (e.g., a control signal sent by a wireless or direct link) or manual means via the control input to the digital signal processor 28, the user may turn down or turn off the environmental sounds, for example when the head-mounted device is in a communication mode (e.g., when a cellular call is initiated or in progress.)

In other examples, the signal processor 26 in the microphone path may perform a first set of signal processing functions and the signal processor 28 in the receiver path may perform a second set of signal processing functions. For instance, processing functions more specific to hearing correction, such as occlusion cancellation and hearing impairment correction, may be performed by the signal processor 28 in the receiver path. Other signal processing functions, such as directional processing and noise cancellation, may be performed by the signal processor 26 in the microphone path. In this manner, while the head-mounted device is in a communication mode (e.g., operating as a wireless head-mounted device for a cellular telephone communication) one signal processor 26 may be dedicated to outgoing signals and the other signal processor 28 may be dedicated to incoming signals. For instance, a first signal processor 26 may be used in the communication mode to process the audio signals received by the microphones 25, 27 to control the microphone directionality such that the voice of the head-mounted device user is prominent in the audio signal, and to filter out environmental noises from the signal. A second signal processor 28 may, for example, be used in the communication mode to process the received signal to correct for hearing impairments of the user.

It should be understood that although shown as two separate processing blocks in FIG. 4, the digital signal processors 26, 28 may be implemented using a single device.

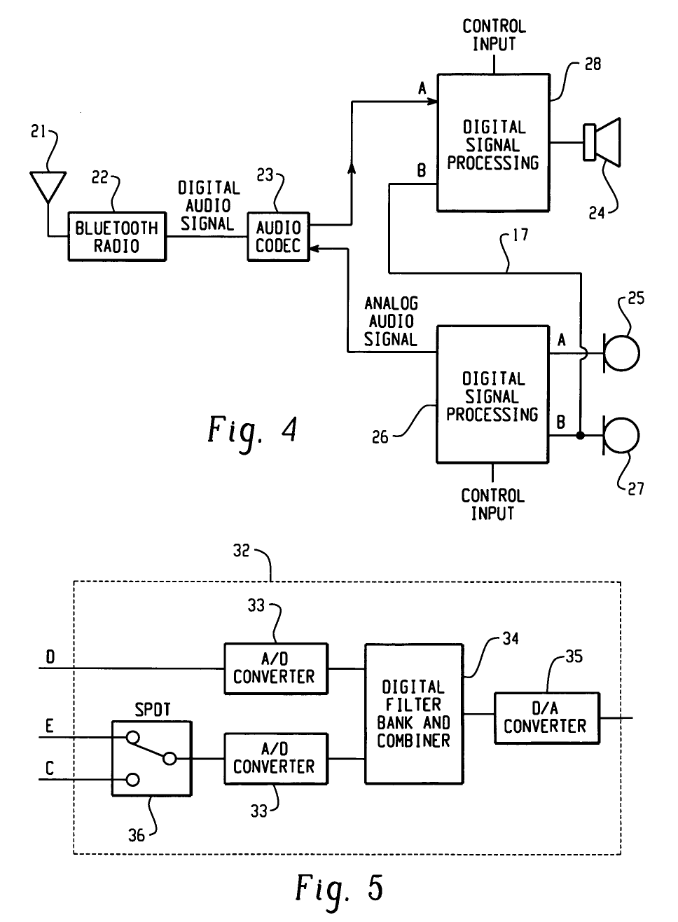

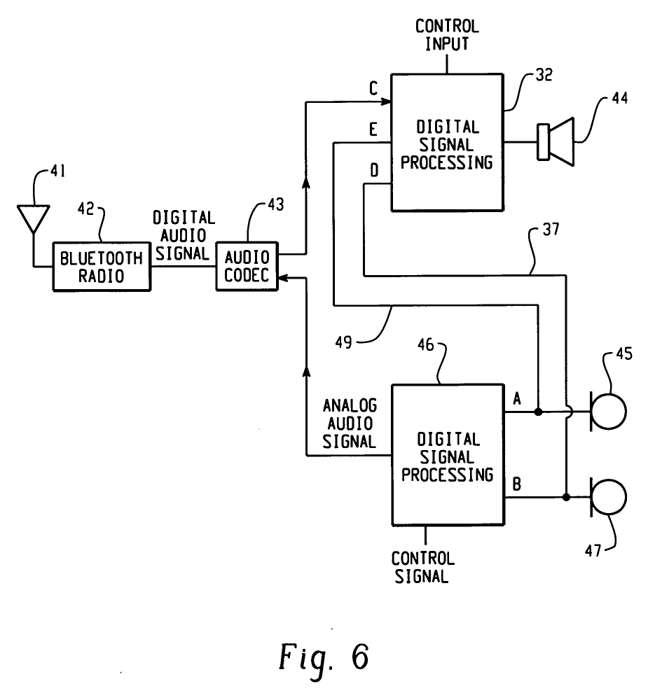

FIG. 5 is a block diagram of another example digital signal processor 32. FIG. 6 is a block diagram of an example communication head-mounted device incorporating the digital signal processor 32 of FIG. 5. In this example, a single-pole double-throw (SPDT) switch 36 is added to the signal processing block 32. Inputs C and E to the digital signal processing block 32 are connected to the poles of the switch 36. The audio signal from an audio CODEC 43 is connected to input C and a microphone 45 is connected to input E of the signal processing block 32. In another example, the digital audio signal from the radio 22 may be input directly to input A of the signal processor 28, instead of being first converted to the analog domain by CODEC 23.

The switch 36 may, for example, be used to enable directional processing in the digital signal processor 32. For example, if input E to the switch 36 is selected, then both microphone signals 45, 47 are available to the signal processor 36, allowing various directional responses to be formed for the benefit of the user. In addition, the switch 36 may be used to toggle the head-mounted device between a communication mode (e.g., a cellular telephone mode) and a hearing instrument mode. For instance, when the head-mounted device is in communication mode, the switch 36 may connect audio signals (C) received from radio communications circuitry 42 (e.g., incoming cellular signals) to the signal processor 32, and may also connect omni-directional audio signals (D) from one of the microphones 47. When the head-mounted device is in hearing instrument mode, the switch 36 may, for example, connect audio signals (D and E) from both microphones 45, 47 to generate a bidirectional audio signal. In one example, the signal processor 32 may receive a control signal from an external device (e.g., a cellular telephone) via the radio communications circuitry 42 to automatically switch the head-mounted device between hearing instrument mode and communication mode, for instance when an incoming cellular call is received.

FIGS. 7A and 7B are a block diagram of an example digital hearing aid system 1012 that may be used in a communication head-mounted device as described herein. The digital hearing aid system 1012 includes several external components 1014, 1016, 1018, 1020, 1022, 1024, 1026, 1028, and, preferably, a single integrated circuit (IC) 1012A. The external components include a pair of microphones 1024, 1026, a tele-coil 1028, a volume control potentiometer 1024, a memory-select toggle switch 1016, battery terminals 1018, 1022, and a speaker 1020.

Sound is received by the pair of microphones 1024, 1026, and converted into electrical signals that are coupled to the FMIC 1012C and RMIC 1012D inputs to the IC 1012A. FMIC refers to “front microphone,” and RMIC refers to “rear microphone.” The microphones 1024, 1026 are biased between a regulated voltage output from the RREG and FREG pins 1012B, and the ground nodes FGND 1012F, RGND 1012G. The regulated voltage output on FREG and RREG is generated internally to the IC 1012A by regulator 1030.

The tele-coil 1028 is a device used in a hearing aid that magnetically couples to a telephone handset and produces an input current that is proportional to the telephone signal. This input current from the tele-coil 1028 is coupled into the rear microphone A/D converter 1032B on the IC 1012A when the switch 1076 is connected to the “T” input pin 1012E, indicating that the user of the hearing aid is talking on a telephone. The tele-coil 1028 is used to prevent acoustic feedback into the system when talking on the telephone.

The volume control potentiometer 1014 is coupled to the volume control input 1012N of the IC. This variable resistor is used to set the volume sensitivity of the digital hearing aid.

The memory-select toggle switch 1016 is coupled between the positive voltage supply VB 1018 to the IC 1012A and the memory-select input pin 1012L. This switch 1016 is used to toggle the digital hearing aid system 1012 between a series of setup configurations. For example, the device may have been previously programmed for a variety of environmental settings, such as quiet listening, listening to music, a noisy setting, etc. For each of these settings, the system parameters of the IC 1012A may have been optimally configured for the particular user. By repeatedly pressing the toggle switch 1016, the user may then toggle through the various configurations stored in the read-only memory 1044 of the IC 1012A.

The battery terminals 1012K, 1012H of the IC 1012A are preferably coupled to a single 1.3 volt zinc-air battery. This battery provides the primary power source for the digital hearing aid system.

The last external component is the speaker 1020. This element is coupled to the differential outputs at pins 1012J, 1012I of the IC 1012A, and converts the processed digital input signals from the two microphones 1024, 1026 into an audible signal for the user of the digital hearing aid system 1012.

There are many circuit blocks within the IC 1012A. Primary sound processing within the system is carried out by the sound processor 1038. A pair of A/D converters 1032A, 1032B are coupled between the front and rear microphones 1024, 1026, and the sound processor 1038, and convert the analog input signals into the digital domain for digital processing by the sound processor 1038. A single D/A converter 1048 converts the processed digital signals back into the analog domain for output by the speaker 1020. Other system elements include a regulator 1030, a volume control A/D 1040, an interface/system controller 1042, an EEPROM memory 1044, a power-on reset circuit 1046, and a oscillator/system clock 1036.

The sound processor 1038 preferably includes a directional processor and headroom expander 1050, a pre-filter 1052, a wide-band twin detector 1054, a band-split filter 1056, a plurality of narrow-band channel processing and twin detectors 1058A-1058D, a summer 1060, a post filter 1062, a notch filter 1064, a volume control circuit 1066, an automatic gain control output circuit 1068, a peak clipping circuit 1070, a squelch circuit 1072, and a tone generator 1074.

Operationally, the sound processor 1038 processes digital sound as follows. Sound signals input to the front and rear microphones 1024, 1026 are coupled to the front and rear A/D converters 1032A, 1032B, which are preferably Sigma-Delta modulators followed by decimation filters that convert the analog sound inputs from the two microphones into a digital equivalent. Note that when a user of the digital hearing aid system is talking on the telephone, the rear A/D converter 1032B is coupled to the tele-coil input “T” 1012E via switch 1076. Both of the front and rear A/D converters 1032A, 1032B are clocked with the output clock signal from the oscillator/system clock 1036. This same output clock signal is also coupled to the sound processor 1038 and the D/A converter 1048.

The front and rear digital sound signals from the two A/D converters 1032A, 1032B are coupled to the directional processor and headroom expander 1050 of the sound processor 1038. The rear A/D converter 1032B is coupled to the processor 1050 through switch 1075. In a first position, the switch 1075 couples the digital output of the rear A/D converter 1032 B to the processor 1050, and in a second position, the switch 1075 couples the digital output of the rear A/D converter 1032B to summation block 1071 for the purpose of compensating for occlusion.

Occlusion of the ear canal may cause amplification of the user's own voice within the ear canal. The rear microphone can be moved inside the ear canal to receive this unwanted signal created by the occlusion effect. The occlusion effect is usually reduced in these types of systems by putting a mechanical vent in the hearing aid. This vent, however, can cause an oscillation problem as the speaker signal feeds back to the microphone(s) through the vent aperture. Another problem associated with traditional venting is a reduced low frequency response (leading to reduced sound quality). Yet another limitation occurs when the direct coupling of ambient sounds results in poor directional performance, particularly in the low frequencies. The hearing instrument system shown in FIGS. 7A and 7B solves these problems by canceling the unwanted signal received by the rear microphone 1026 by feeding back the rear signal from the A/D converter 1032B to summation circuit 1071. The summation circuit 1071 then subtracts the unwanted signal from the processed composite signal to thereby compensate for the occlusion effect.

The directional processor and headroom expander 1050 includes a combination of filtering and delay elements that, when applied to the two digital input signals, forms a single, directionally-sensitive response. This directionally-sensitive response is generated such that the gain of the directional processor 1050 will be a maximum value for sounds coming from the front microphone 1024 and will be a minimum value for sounds coming from the rear microphone 1026.

The headroom expander portion of the processor 1050 significantly extends the dynamic range of the A/D conversion, which is very important for high fidelity audio signal processing. It does this by dynamically adjusting the A/D converters 1032A/1032B operating points. The headroom expander 1050 adjusts the gain before and after the A/D conversion so that the total gain remains unchanged, but the intrinsic dynamic range of the A/D converter block 1032A/1032B is optimized to the level of the signal being processed.

The output from the directional processor and headroom expander 1050 is coupled to a pre-filter 1052, which is a general-purpose filter for pre-conditioning the sound signal prior to any further signal processing steps. This “pre-conditioning” can take many forms, and, in combination with corresponding “post-conditioning” in the post filter 1062, can be used to generate special effects that may be suited to only a particular class of users. For example, the pre-filter 1052 could be configured to mimic the transfer function of the user's middle ear, effectively putting the sound signal into the “cochlear domain.” Signal processing algorithms to correct a hearing impairment based on, for example, inner hair cell loss and outer hair cell loss, could be applied by the sound processor 1038. Subsequently, the post-filter 1062 could be configured with the inverse response of the pre-filter 1052 in order to convert the sound signal back into the “acoustic domain” from the “cochlear domain.” Of course, other pre-conditioning/post-conditioning configurations and corresponding signal processing algorithms could be utilized.

The pre-conditioned digital sound signal is then coupled to the band-split filter 1056, which preferably includes a bank of filters with variable corner frequencies and pass-band gains. These filters are used to split the single input signal into four distinct frequency bands. The four output signals from the band-split filter 1056 are preferably in-phase so that when they are summed together in block 1060, after channel processing, nulls or peaks in the composite signal (from the summer) are minimized.

Channel processing of the four distinct frequency bands from the band-split filter 1056 is accomplished by a plurality of channel processing/twin detector blocks 1058A-1058D. Although four blocks are shown in FIGS. 77B, it should be clear that more than four (or less than four) frequency bands could be generated in the band-split filter 1056, and thus more or less than four channel processing/twin detector blocks 1058 may be utilized with the system.

Each of the channel processing/twin detectors 1058A-1058D provide an automatic gain control (“AGC”) function that provides compression and gain on the particular frequency band (channel) being processed. Compression of the channel signals permits quieter sounds to be amplified at a higher gain than louder sounds, for which the gain is compressed. In this manner, the user of the system can hear the full range of sounds since the circuits 1058A-1058D compress the full range of normal hearing into the reduced dynamic range of the individual user as a function of the individual user's hearing loss within the particular frequency band of the channel.

The channel processing blocks 1058A-1058D can be configured to employ a twin detector average detection scheme while compressing the input signals. This twin detection scheme includes both slow and fast attack/release tracking modules that allow for fast response to transients (in the fast tracking module), while preventing annoying pumping of the input signal (in the slow tracking module) that only a fast time constant would produce. The outputs of the fast and slow tracking modules are compared, and the compression slope is then adjusted accordingly. The compression ratio, channel gain, lower and upper thresholds (return to linear point), and the fast and slow time constants (of the fast and slow tracking modules) can be independently programmed and saved in memory 1044 for each of the plurality of channel processing blocks 1058A-1058D.

FIG. 7B also shows a communication bus 1059, which may include one or more connections, for coupling the plurality of channel processing blocks 1058A-1058D. This inter-channel communication bus 1059 can be used to communicate information between the plurality of channel processing blocks 1058A-1058D such that each channel (frequency band) can take into account the “energy” level (or some other measure) from the other channel processing blocks. Preferably, each channel processing block 1058A-1058D would take into account the “energy” level from the higher frequency channels. In addition, the “energy” level from the wide-band detector 1054 may be used by each of the relatively narrow-band channel processing blocks 1058A-1058D when processing their individual input signals.

After channel processing is complete, the four channel signals are summed by summer 1060 to form a composite signal. This composite signal is then coupled to the post-filter 1062, which may apply a post-processing filter function as discussed above. Following post-processing, the composite signal is then applied to a notch-filter 1064, that attenuates a narrow band of frequencies that is adjustable in the frequency range where hearing aids tend to oscillate. This notch filter 1064 is used to reduce feedback and prevent unwanted “whistling” of the device. Preferably, the notch filter 1064 may include a dynamic transfer function that changes the depth of the notch based upon the magnitude of the input signal.

Following the notch filter 1064, the composite signal is then coupled to a volume control circuit 1066. The volume control circuit 1066 receives a digital value from the volume control A/D 1040, which indicates the desired volume level set by the user via potentiometer 1014, and uses this stored digital value to set the gain of an included amplifier circuit.

From the volume control circuit, the composite signal is then coupled to the AGC-output block 1068. The AGC-output circuit 1068 is a high compression ratio, low distortion limiter that is used to prevent pathological signals from causing large scale distorted output signals from the speaker 1020 that could be painful and annoying to the user of the device. The composite signal is coupled from the AGC-output circuit 1068 to a squelch circuit 1072, that performs an expansion on low-level signals below an adjustable threshold. The squelch circuit 1072 uses an output signal from the wide-band detector 1054 for this purpose. The expansion of the low-level signals attenuates noise from the microphones and other circuits when the input S/N ratio is small, thus producing a lower noise signal during quiet situations. Also shown coupled to the squelch circuit 1072 is a tone generator block 1074, which is included for calibration and testing of the system.

The output of the squelch circuit 1072 is coupled to one input of summer 1071. The other input to the summer 1071 is from the output of the rear A/D converter 1032B, when the switch 1075 is in the second position. These two signals are summed in summer 1071, and passed along to the interpolator and peak clipping circuit 1070. This circuit 1070 also operates on pathological signals, but it operates almost instantaneously to large peak signals and is high distortion limiting. The interpolator shifts the signal up in frequency as part of the D/A process and then the signal is clipped so that the distortion products do not alias back into the baseband frequency range.

The output of the interpolator and peak clipping circuit 1070 is coupled from the sound processor 1038 to the D/A H-Bridge 1048. This circuit 1048 converts the digital representation of the input sound signals to a pulse density modulated representation with complimentary outputs. These outputs are coupled off-chip through outputs 1012J, 1012I to the speaker 1020, which low-pass filters the outputs and produces an acoustic analog of the output signals. The D/A H-Bridge 1048 includes an interpolator, a digital Delta-Sigma modulator, and an H-Bridge output stage. The D/A H-Bridge 1048 is also coupled to and receives the clock signal from the oscillator/system clock 1036.

The interface/system controller 1042 is coupled between a serial data interface pin 1012M on the IC 1012, and the sound processor 1038. This interface is used to communicate with an external controller for the purpose of setting the parameters of the system. These parameters can be stored on-chip in the EEPROM 1044. If a “black-out” or “brown-out” condition occurs, then the power-on reset circuit 1046 can be used to signal the interface/system controller 1042 to configure the system into a known state. Such a condition can occur, for example, if the battery fails.

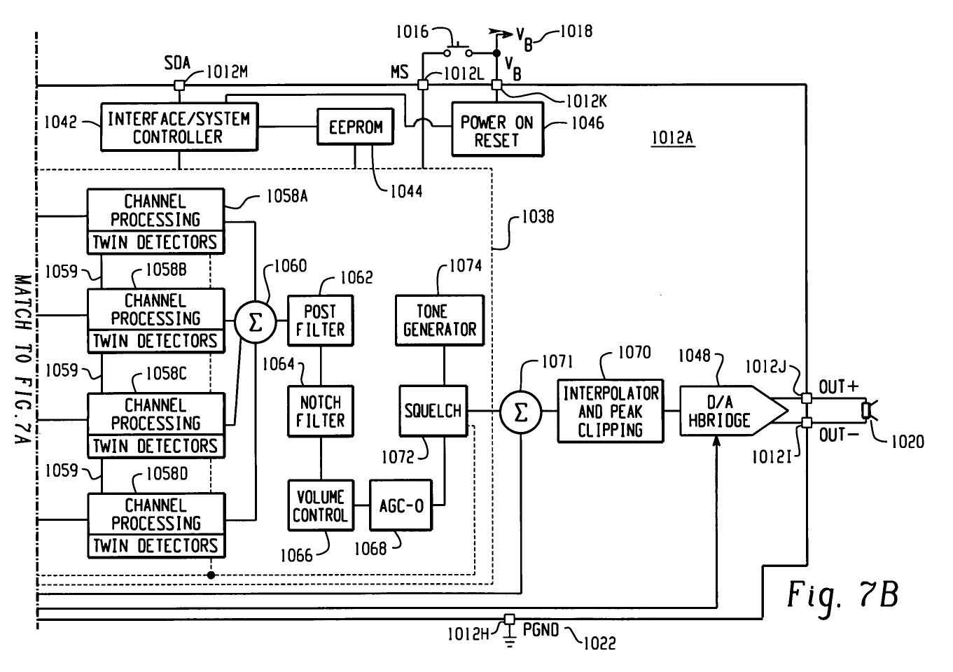

FIG. 8 shows an example of a communication head-mounted device that is configured to listen to a high fidelity external stereo audio source such as a CD player or MP3 player. In this example, the left and right side audio feeds 61, 62 from an external source are connected to input E on each digital signal processing block 56, 58, respectively, where the audio feeds 61, 62 are processed to provide an optimum audio response. The left side audio output is fed, as shown, through stereo connector 64 to a left speaker 65. The right side audio feed 62 is connected through stereo connector 64 to input E of the other signal processing block 58, processed to optimize the audio response, and then routed to a right speaker 54. When the user wishes to listen to the external stereo audio source, switches in both digital signal processing blocks 56, 58 may be set in position E to receive the stereo audio feed. When a call arrives, the switches in both digital signal processing blocks 56, 58 may be switched to position C, via the control input, in order to turn off the stereo feed and allows the user to answer the call.

FIG. 9 shows another example head-mounted device having connections 86 and 87 from a radio communications circuitry 72 to a programming port of the digital signal processing blocks 76, 78. If the head-mounted device user is not on a call and the head-mounted device is configured in a stereo mode with left and right audio feeds 81, 82, then the digital signal processing blocks 76, 78, as a result of individually adjustable filters (amplitude and bandwidth) within the processors' filter banks, can be made to function as an audio equalizer. That is, the audio characteristics of the left and right audio feeds 81, 82 may be altered by the digital signal processing blocks 76, 78 using pre-programmed equalizer settings, such as amplitude and bandwidth settings. Using these settings, the digital signal processing blocks 76, 78 may divide a given signal bandwidth into a number of bins, wherein each bin may be of equal or different bandwidths. In addition, each bin may be capable of individual amplitude adjustment. An application running on a computer, which emulates a graphical equalizer, can be displayed on a computer screen and adjusted in real time under user control. The equalizer settings may be transferred over the wireless link to the head-mounted device, where the amplitude and bandwidth settings for each filter within the filter bank of the signal processors 76, 78 are programmed via the programming ports of digital signal processing blocks 76, 78. It should be understood that other devices may also be used to program the head-mounted device equalizer settings, such as an MP3 player or other mobile device in wired or wireless communication with the head-mounted device.

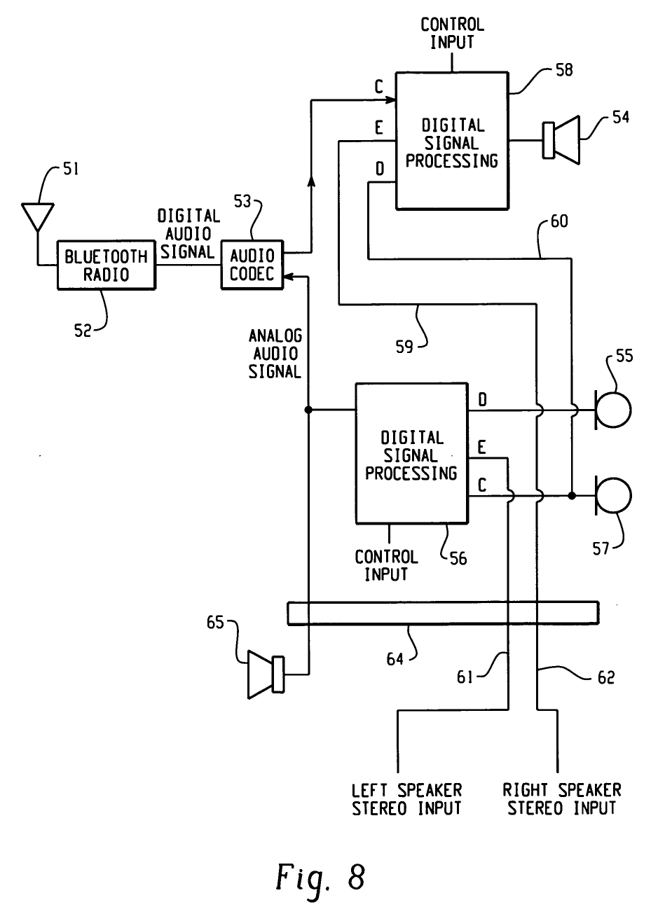

FIG. 10 shows an example of a system for downloading ESNRAs over a network 110 (e.g. the Internet) for use in a head-mounted device. The system includes a network server 100 having a processor 102 that stores ESNRAs in memory 104. Also included is a network device 120 which may communicate with the server 100 over the network 110 to download one or more of the ESNRAs. The network device 120 may be any device that is capable of downloading information from a server 100 over the network 110 such as a computer, a personal data assistant (PDA), a cellular phone, or other network-enabled devices. The network device 120 may even be part of the head-mounted device.

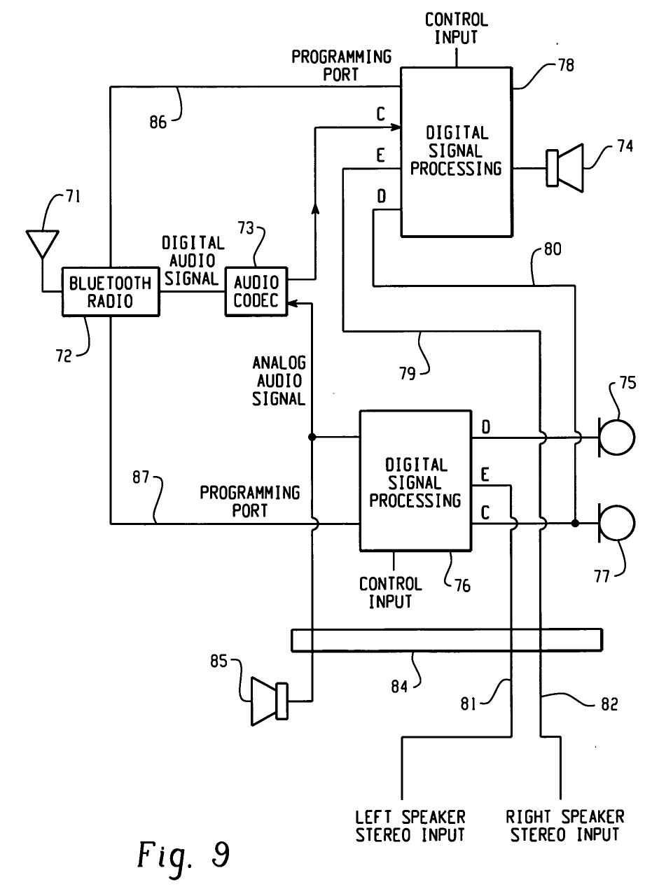

FIG. 11 shows an example of a system for providing environment specific noise reduction in a head-mounted device. This system is similar to the example of FIG. 10, with the addition of a head-mounted device 230 that may communicate with the network device 220 via a wired 222 or wireless 224 link. The head-mounted device 230 may be mounted on any part of the user's head. For example, it could rest behind a single ear, it could rest on both ears like a set of headphones, or it could rest within the ear canal like a hearing instrument.

The head-mounted device may communicate by a wired 222 or wireless 224 link. A wireless link 224 between the head-mounted device 230 and the network device 220 may, for example, be provided using the wireless communications circuitry described above. In addition, the head-mounted device 230 may include a communications port for wired communications 222 with the network device 220. In another example, the network device 220 may have wired or wireless network communications circuitry that is included within the same physical structure as the head-mounted device 230.

In operation, one or more of the ESNRAs 205 may be transferred from the network device 220 into a memory in the head-mounted device 230. The head-mounted device 230 may then operate to filter environmental sounds from an audio signal(s) using one or more of the ESNRAs 205 stored in its memory. The one or more ESNRAs 205 used to filter an audio signal(s) may be selected from memory by the device user 240, for instance by depressing an input device (e.g., a switch). In another example, the ESNRAs 205 may be automatically selected from memory by a device processor based on an analysis of the environmental noise present in the audio signal(s). The filtered audio signal(s) may be transmitted to the user 240 via one or more speakers 235. In addition, filtered audio signals may be transmitted to an external device 252 (e.g., a cellular phone).

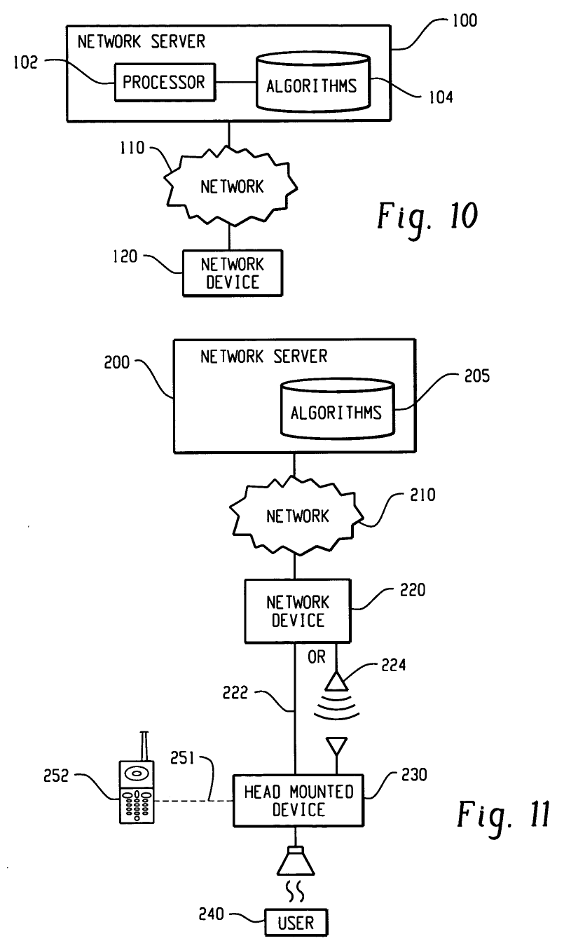

FIG. 12 is the same as FIG. 11 except that it adds an algorithm generating processor 260. The algorithm generating processor 260 functions to receive sound recordings and is operable to create algorithms that are specifically tailored to a particular environment and are designed to cancel or reduce the environmental noise in the recording. The designed algorithms are transferred to the network server 200 and stored as ESNRAs 205. The algorithm generating processor 260 may, for example, be operated by the head-mounted device manufacturer.

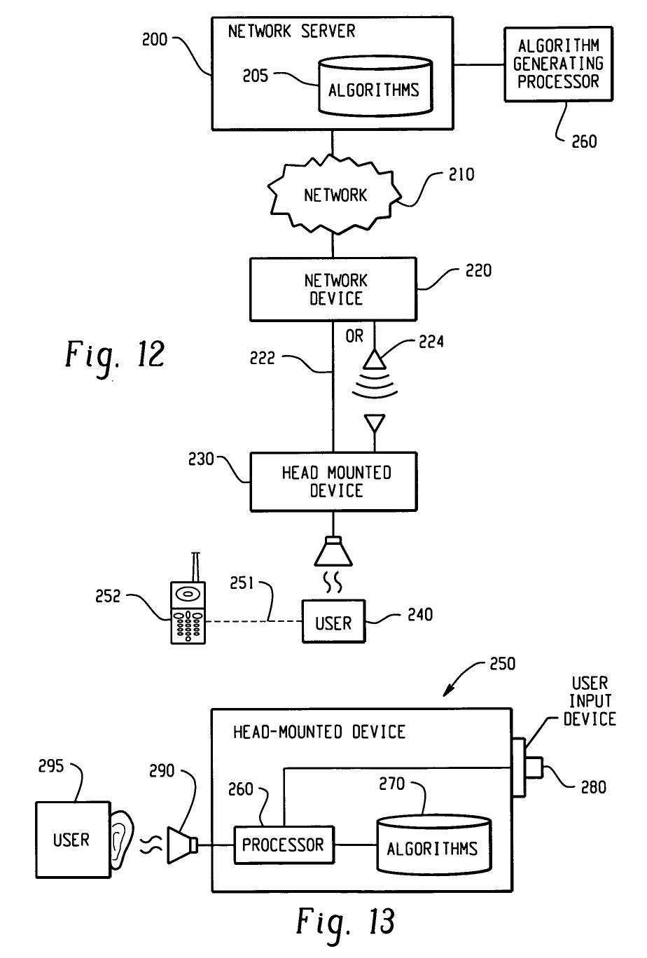

FIG. 13 shows an example head-mounted device 250 that contains a processor 260, a memory for storing ESNRAs 270, a user input device 280, and a speaker 290. The user input device 280 may include a push-button switch, a toggle switch, or other type of input device, and is operable to communicate with the processor 260 to select a certain ESNRA stored in memory 270. This allows the user 295 to manually select an appropriate ESNRA for a particular environment. For example, a user may toggle through a plurality of stored ESNRAs until a desired ESNRA is selected. In another example, the processor 260 may be able to automatically recognize which ESNRA would be most effective for a particular environment. The processor 260 is operable to filter environmental sounds using the selected ESNRA to create a filtered audio signal, which may be transmitted to the user 295 via the speaker 290.

In operation, an example head-mounted device functions to provide environmental noise reduction. In a first example, the head-mounted device operates in a communications mode. In a communications mode the head-mounted device is used in conjunction with a communications device, such as a cell phone. The connection to the communications device may be wireless or by a wired link. In the communications mode, the ESNRAs may be applied to outgoing signals in order to reduce environmental noise heard by the other party to the call. Thus, the environmental sound present in the user's location can be reduced as it is heard by the other party to the call. With respect to incoming signals, the ESNRAs may be applied to (a) reduce environmental noise present on the other end of the call or (b) to filter noise from the user's environment. Thus, the user can benefit by having the environmental noise present in the other party's location reduced, or by filtering environmental noise present in the user's location. In another example, the ESNRAs could be used to reduce noise from both the user's location and the other party's location at the same time.

In another example, the head-mounted device may operate in a noise reduction only mode. In the noise reduction only mode the ESNRA function is applied to environmental signals in the user's location. This mode, for example, would aid users in hearing face-to-face communications in noisy environments. It could also be used, for example, to listen to television or music in a noisy environment.

In another example, the head-mounted device may include a network device. The network device may be connected by a wire and worn on another part of the body or it may be included in the structure of the head-mounted device itself.

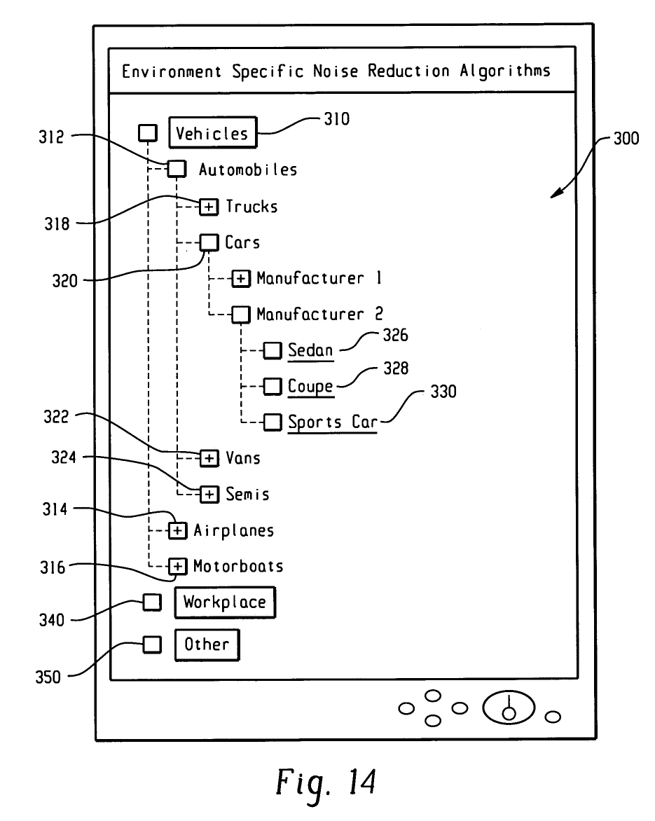

FIG. 14 shows an example internet web-page 300 that displays several ESNRAs available for download by a network device. In this example the ESNRAs are arranged in a menu system and contain algorithms for categories such as vehicles 310, particular types of vehicles 312, 314, 316, 318, 320, 322, 324 and even as specific as particular models of vehicles 326, 328, 330. ESNRAs for automobiles 312, airplanes 314, and motorboats 316 are all examples of vehicle algorithms that could be stored and made accessible on the internet web-page 300.

A category of ESNRAs for various workplace environments 340 might also be made available for download. ESNRAs for manufacturing, construction, or for telephone call-center workplaces are some examples of workplace environments that might be made available for download on the internet web-page 300.

A broad “other” category 350 is also shown in the example web-page 300. This category could contain various ESNRAs specifically tailored to reduce noise in many different environments, such as a party, a restaurant, a city street, a bar, a concert, or a sporting event, among others. ESNRAs for these environments could be created with varying degrees of specificity, for example, having a loud and a quiet restaurant algorithm or an indoor and outdoor sporting event algorithm. Other examples of algorithms are also possible.

Recordings to make the algorithms could come from various sources. For example, the manufacturer or a third party might make the recording themselves. The manufacturer of a vehicle might send in a recording. The owner of a workplace could send a recording in. As described below, a user could send in a recording and have it made available on the web-site. Additionally, algorithms created by sources other than the party maintaining the web-page could be included on the web-page.

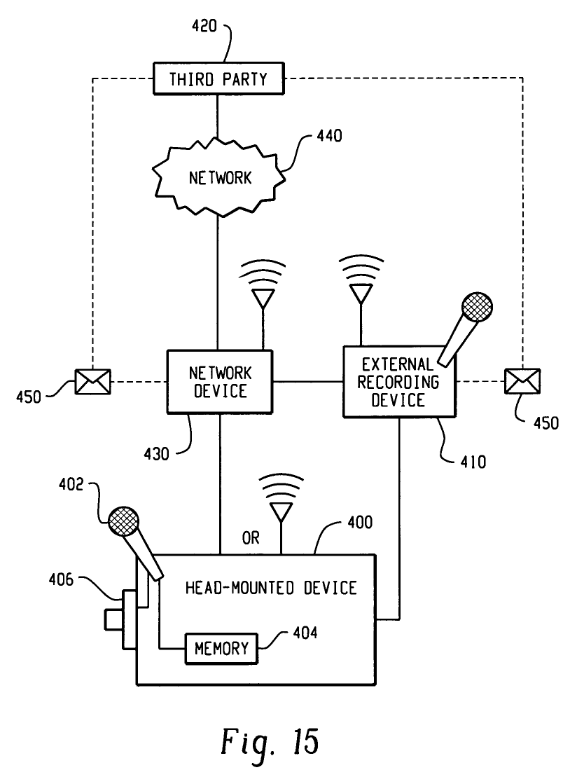

FIG. 15 shows a block diagram of an example way to utilize custom designed algorithms that are even more specific to the user's environment. The head-mounted device 400 shown in FIG. 15 includes a microphone 402 that may be connected to a memory 404. The microphone 402 is operable to pick up environmental audio signals. The user can activate an input device 406 on the head-mounted device 400 to begin recording of the environmental audio signals into memory 404 through the microphone 402.

An external recording device 410 may also be used to create a recording. A recording device is a device that is operable to record sound. Examples of external recording devices are a tape recorder, a personal computer equipped with a microphone and recording software, and a video camera. In some examples, the head-mounted device 400 may be connected by a wired or wireless connection to the external recording device 410. This could enable the environmental samples stored in the memory to be transmitted to the external recording device where they could be sent to the third party 420 or put in another data form and sent to a third party.

Once a recording is made, it is transferred to a third party 420, such as the manufacturer of the head-mounted device. The third party then creates a custom-designed algorithm that will cancel or reduce the background noise in the recording.

The recording can be sent by the user to the third party by first transferring the recording electronically to a network device 430 via a wired or wireless connection, and then uploading the recording to a network 440 from the network device 430. The third party 420 could then access the recording by downloading it from the network 440. One example of a way to upload and download the recordings to and from the network 440 is through an internet web-page interface that facilitates the uploading and downloading of recordings.

Another way to transfer the recording is by first transferring the recording from the network device 430 or the external recording device 410 to an external storage media 450, and then physically delivering the external storage media 450 to the third party 420. An external storage media 450 is a device that can store data and is physically portable. Some examples of external storage media 450 are compact disks, floppy disks, and cassette tapes.

Yet another way to transfer the recording from the memory 404 in the head-mounted device 400 to the third party 410 is by directly exporting the recording to the external recording device 410 through a wired or wireless connection. The external recording device 410 could then be used as above to transfer the recording to the third party 420.

When the third party 420 receives the recording and creates a custom ESNRA, the third party may transfer the custom ESNRA back to the user for utilization in the user's head-mounted device. The third party could transfer the custom ESNRA by uploading it to the network 440, and the user would then be able to download the custom ESNRA from the network 440 by a network device 430. For example, the third party could upload the custom ESNRA to an internet web-page where the user could access it and download it through a network device 430. The user could then transfer the custom ESNRA to the head-mounted device 400 from the network device 430 through a wired or wireless electronic link. The custom ESNRA would then be available for the user to select for reducing noise. The third party 420 could also transfer the custom ESNRA back to the user by physical delivery of external storage media 450 containing the custom ESNRA.

While various features of the claimed invention are presented above, it should be understood that the features may be used singly or in any combination thereof. Therefore, the claimed invention is not to be limited to only the specific examples depicted herein.

Further, it should be understood that variations and modifications may occur to those skilled in the art to which the claimed invention pertains. The disclosure may enable those skilled in the art to make and use embodiments having alternative elements that likewise correspond to the elements of the invention recited in the claims. The scope of the present invention is accordingly defined as set forth in the appended claims.

As an example of an alternative embodiment the user could obtain a customized ESNRA using a personal computer or other personal computing device such as a personal data assistant to create custom ESNRAs from recordings. The user would transfer the recording to the personal computing device, and run an algorithm generating software program that would convert sound recordings into ESNRAs. The user would then transfer the custom ESNRA to the head-mounted device.

It is claimed:

1. A system for providing environment specific noise reduction in a head-mounted device comprising:
a network server operable to communicate over a network, and operable to store a plurality of environment specific noise reduction algorithms (ESNRAs), an ESNRA being a preset algorithm that is designed to reduce noise patterns that are specific to selected environments; and
a network device operable to communicate with the network, and operable to download one or more of the plurality of ESNRAs from the network server for use in a head-mounted device.

2. The system of claim 1, further comprising:
a head-mounted device operable to receive the downloaded ESNRAs, and to filter received environmental sounds using one or more of the downloaded ESNRAs.

3. The system of claim 2, wherein the head-mounted device is operable to transmit a filtered audio signal to a user.

4. The system of claim 2, wherein the head-mounted device is operable to transmit a filtered audio signal to an external device.

5. The system of claim 2, wherein the network device is part of the head-mounted device.

6. The system of claim 1 further comprising an algorithm generating processor operable to receive sound recordings and generate ESNRAs specifically tailored to reduce noise in the sound recordings, and operable to store the algorithms on the network server.

7. The system of claim 1, wherein the one or more of the plurality of ESNRAs stored on the network server are transferred to an external storage media, and transferred via the external storage media to a network device.

8. The system of claim 2, the head-mounted device further comprising:
a processor;
wherein the processor is operable to recognize an appropriate ESNRA to reduce the noise in an audio signal, is operable to apply the appropriate ESNRA to the audio signal, and is operable to transmit a filtered audio signal to a user.

9. The system of claim 2, the head-set further comprising:
a microphone;
wherein the head-mounted device is operable to record audio signals picked up by the microphone.

10. The system of claim 9, wherein the recorded audio signals are transferred to a third party to generate an ESNRA based on the recorded audio signals.

11. The system of claim 1, further comprising:
a recording device;
wherein the recording device is operable to record audio signals.

12. The system of claim 11, wherein the recorded audio signals are transferred to a third party to generate an ESNRA based on the recorded audio signals.

13. The system of claim 12, wherein the generated ESNRA is transferred to the head-mounted device.

14. The system of claim 13, wherein the custom ESNRA is transferred to the head-mounted device by the third party uploading the custom ESNRA to an internet web-page, the network device downloading the custom ESNRA from the internet web-page, and the network device transferring the custom ESNRA to the head-mounted device.

15. A network server for providing environment specific noise reduction algorithms (ESNRAs) for use by a head-mounted device, comprising:
a processor operable to store ESNRAs in memory, and operable to communicate over a network;
wherein the ESNRAs may be downloaded over the network from the network server for use in the head-mounted device;
wherein the head-mounted device is operable to use the downloaded ESNRAs to filter environmental noise from an audio signal.

16. The network server of claim 15, wherein the server is accessible via an internet web-page.

17. The network server of claim 15, wherein a network device is operable to download an ESNRA over the network.

18. The network server of claim 17, wherein the network device is a personal computer.

19. The network server of claim 17, wherein the network device is a hand-held personal data assistant.

20. The network server of claim 17, wherein the network device is a cellular phone.

21. The network server of claim 17, wherein the network device is part of a head-mounted device.

22. A head-mounted device for providing environment specific noise reduction comprising:
a memory device for storing a plurality of environment-specific noise reduction algorithms (ESNRAs);
a user input device operable to select one or more of the ESNRAs;
a processor operable to filter environmental sounds using the selected ESNRA to create a filtered audio signal.

23. The head-mounted device of claim 22, further comprising one or more speakers transmitting the filtered audio signal to a user.

24. The head-mounted device of claim 23, further comprising communications circuitry for communicating with an external device, wherein the head-mounted device is operable to transmit the filtered audio signal to the external device.

25. The head-mounted device of claim 24, wherein the external device is a cellular phone.

26. The head-mounted device of claim 22, wherein the device is operable to communicate with a network device, and to receive ESNRAs from the network device.

27. The head-mounted device of claim 22, wherein the user input device is operable to select a plurality of ESNRAs, and the processor is operable to filter environmental sounds using the selected plurality of ESNRAs.

28. The head-mounted device of claim 22,
wherein the head-mounted device is operable in a communications mode;
wherein in the communications mode the processor is operable to receive an audio signal from an external device, is operable to filter the audio signal by using the selected ESNRA, and is operable to transmit a filtered audio signal from the external device to a user via the speaker.

29. The head-mounted device of claim 22, further comprising:
a microphone;
wherein the head-mounted device is operable in a communications mode;
wherein in the communications mode the processor is operable to receive an audio signal from the microphone, is operable to filter the audio signal by using a user-selected ESNRA, and is operable to transmit a filtered audio signal to an external device.

30. The head-mounted device of claim 28, wherein in the communications mode the processor is further operable to receive an audio signal from the microphone, to filter the audio signal by using a user-selected ESNRA, and to transmit a filtered audio signal to an external device.

31. The head-mounted device of claim 30, wherein in the communications mode processor is further operable to process an audio signal received by the microphone to control the directionality of the microphone such that the voice of the head-mounted device user is prominent in the audio signal.

32. The head-mounted device of claim 22, further comprising:
a microphone;
wherein the processor is operable to receive an audio signal from the microphone, is operable to filter the audio signal by using the selected ESNRA, and is operable to transmit a filtered audio signal to a user via the speaker.

33. The head-mounted device of claim 32, wherein the head-mounted device is operable in a hearing instrument mode;
wherein in the hearing instrument mode the processor is operable to process signals to compensate for a hearing impairment of a user.

34. The head-mounted device of claim 32, wherein in the hearing instrument mode the processor is operable to receive an audio signal from the microphone, to filter the audio signal by using the selected ESNRA, and to transmit a filtered audio signal to an external device;
wherein the processor is operable to receive an audio signal from an external device, to filter the audio signal by using a user-selected ESNRA, and is operable to transmit a filtered audio signal from the external device to a user via the speaker; and
wherein the processor is further operable to process the signals received from the external device to compensate for a hearing impairment of a user.

35. The head-mounted device of claim 32,
wherein in the hearing instrument mode the processor is operable to process an audio signal received by the microphone to control the directionality of the microphone such that the voice of the head-mounted device user is prominent in the audio signal.

36. The head-mounted device of claim 33,
wherein in the hearing instrument mode the processor is operable to process an audio signal received by the microphone to control the directionality of the microphone such that the voice of the head-mounted device user is prominent in the audio signal.

37. The head-mounted device of claim 34,
wherein in the hearing instrument mode the processor is further operable to process an audio signal received by the microphone to control the directionality of the microphone such that the voice of the head-mounted device user is prominent in the audio signal.

38. The head-mounted device of claim 30, wherein the external device is a cellular telephone.

39. The head-mounted device of claim 34, wherein the external device is a cellular telephone.

40. The head-mounted device of claim 22 further comprising:
a microphone;
wherein the head-mounted device is operable to record environmental noise picked up by the microphone.

41. The head-mounted device of claim 40, wherein the recording is transmitted to a third party to generate an ESNRA based on the recorded audio signal.

42. The head-mounted device of claim 41, wherein the generated ESNRA is transferred to the head-mounted device.

43. The head-mounted device of claim 22 further comprising:
a recording device;
wherein the recording device is operable to record environmental noise.

44. The head-mounted device of claim 43, wherein the recording is transmitted to a third party to generate an ESNRA based on the recorded audio signal.

45. The head-mounted device of claim 44 wherein the generated ESNRA is transferred to the head-mounted device.

46. The head-mounted device of claim 22, wherein the head-mounted device is operable to filter environmental sounds by utilizing a custom ESNRA that was created on a personal computing device from a recording made by a user.
